(19) United States
(12) Patent Application Publication
(10) Pub. No.: US 2009/0027482 A1
(43) Pub. Date: Jan. 29, 2009

(54) Full duplex network based appliance and method

(75) Inventors: Timothy N. Emig, Louisville, KY (US); David F. Gibbs, Louisville, KY (US)

Correspondence Address: FOLEY AND LARDNER LLP;SUITE 500, 3000 K STREET NW, WASHINGTON, DC, 20007, US

(73) Assignee: NOMAD INNOVATIONS, LLC

(21) Appl. No.: 12/219,578

(22) Filed: Jul. 24, 2008

Related U.S. Application Data
(60) Provisional application No. 60/952,025, filed on Jul. 26, 2007.

(51) Int. Cl. H04N 5/28

(52) U.S. Cl. 348/14.02; 348/E05.061

(57) ABSTRACT

A duplex communications device provides full duplex audio and video communications between a first location and a second location. The device includes a transceiver unit at the first location configured to transmit audio and video data over a wireless network to the second location where a broadcast studio may be located. The transceiver unit is further configured to receive audio and/or video data sent over the wireless network from the second location back to the first location. The audio and/or video data is provided to at least one of an on-air talent and a cameraperson located at the first location.

### CROSS-REFERENCE TO RELATED APPLICATION

This application claims priority from U.S. Provisional Patent Application No. 60/952,025, filed on Jul. 26, 2007. The contents of that application are hereby incorporated by reference in its entirety.

### BACKGROUND OF THE INVENTION

The present invention relates generally to sending audio and video data between one or more remote locations, such as news-gathering scenes, and a central location, such as a television studio, and to other communications between such locations.

Conventional systems for enabling remotely-located television reporters to report stories on-the-air have limitations. First, dedicated communication links are utilized to provide information from the remotely-located reporter to the television studio (central location). Those dedicated links usually require a specially outfitted television truck or van with a large microwave antenna that has to be raised upwards, to enable communications with the television studio. The large microwave antenna on the television truck or van has to be pointed in the direction of a broadcast studio or a closely-located repeater tower (in a case where the broadcast studio's antenna is not within line of sight), in order to establish a line-of-sight communications link with the broadcast studio. Alternatively, a satellite antenna (that has to be precisely pointed at a geosynchronous satellite) may be mounted on the truck or van for the same purpose.

Second, it is often the case that the remotely-located television reporter (also referred to herein as “on-air talent”) is not directly synchronized with the actual television broadcast being made from the broadcast studio to its television customers. Specifically, the remotely-located television reporter is typically given an indication as to when he or she will be on-the-air, by way of a separate audio feed that provides a producer's instructions to the reporter (e.g., 5-4-3-2-1, on the air). This separate audio feed is typically called an Interruptible Fold Back (IFB) feed, which is used by the television producer (located at the television studio) to instruct the remotely-located reporter and the camera operator before and while they are on-the-air. The IFB feed is typically provided by way of a cellular call made between the remotely-located site and the television studio. However, such a link is not dependable, and a dropped cellular call during the broadcast can result in an embarrassing situation while the on-the-air broadcast is being made. The IFB is a back channel used primarily for command and control of the camera and the on-air talent. In those instances when the IFB connection is lost or dropped, the remotely-located reporter and his/her cameraperson may be “in the dark,” and not know what they should be doing or which upcoming questions will be put to them by the anchorperson.

### SUMMARY OF THE INVENTION

One aspect of the invention relates to a duplex communications device between a first location and a second location. The device includes an encoder unit configured to encode first audio and video data collected at the first location. The device further includes an upconverter unit that is configured to convert the encoded first audio and video data at a baseband frequency to an uplink frequency suitable for over-the-air transmission. The device also includes a transceiver unit configured to transmit the upconverted first audio and video data over a network to the second location. The transceiver unit is further configured to receive encoded second audio and/or video data sent over the network from the second location at a downlink frequency suitable for over-the-air transmission. The device also includes a downconverter unit that is configured to convert the encoded second audio and/or video data to a baseband frequency, to obtain baseband encoded second audio and/or video data. The device still further includes a decoder unit that is configured to decode the baseband encoded second audio and/or video data to obtain decoded second audio and/or video data. Another aspect of the invention relates to a method for providing full duplex communications between a first location and a second location. The method comprises encoding first audio and video data at the first location; converting, at the first location, the encoded first audio and video data to a particular protocol and/or frequency suitable for transmission over a network; and transmitting, at the first location, the upconverted first audio and video data over a network to the second location. The method further comprises receiving, at the first location, encoded second audio and/or video data sent over the network from the second location at the particular protocol and/or frequency suitable for transmission over the network; converting, at the first location, the encoded second audio and/or video data to strip the particular protocol and/or frequency used for transmission over the network from the received second audio and/or video data, to obtain baseband encoded second audio and/or video data; and decoding, at the first location, the baseband encoded second audio and/or video data to obtain decoded audio and/or video data.

According to another aspect of the invention, there is provided a duplex communications device between a first location and a second location. The device includes a transceiver unit at the first location configured to transmit first audio and video data over a wireless network to the second location. The transceiver unit is further configured to receive second audio and/or video data sent over the wireless network from the second location. The second audio and/or video data is provided to at least one of an on-air talent and a cameraperson at the second location.

Other features and advantages of the present invention will become apparent to those skilled in the art from the following detailed description and accompanying drawings. It should be understood, however, that the detailed description and specific examples, while indicating preferred embodiments of the present invention, are given by way of illustration and not limitation. Many modifications and changes within the scope of the present invention may be made without departing from the spirit thereof, and the invention includes all such modifications.

### BRIEF DESCRIPTION OF THE DRAWINGS

Exemplary embodiments will hereafter be described with reference to the accompanying drawings, wherein like numerals depict like elements, and in which:

FIG. 1 is a diagram showing components of a full duplex appliance according to an embodiment of the invention;

FIG. 2 is a diagram showing a microcontroller of a full duplex appliance according to an embodiment of the invention; and

FIG. 3 is a diagram showing a studio link according to an embodiment of the invention.

### DETAILED DESCRIPTION OF THE PREFERRED EMBODIMENTS

In the following description, for the purposes of explanation, numerous specific details are set forth in order to provide a thorough understanding of the present invention. It will be evident to one skilled in the art, however, that the exemplary embodiments may be practiced without these specific details. In other instances, structures and devices are shown in diagram form in order to facilitate description of the exemplary embodiments.

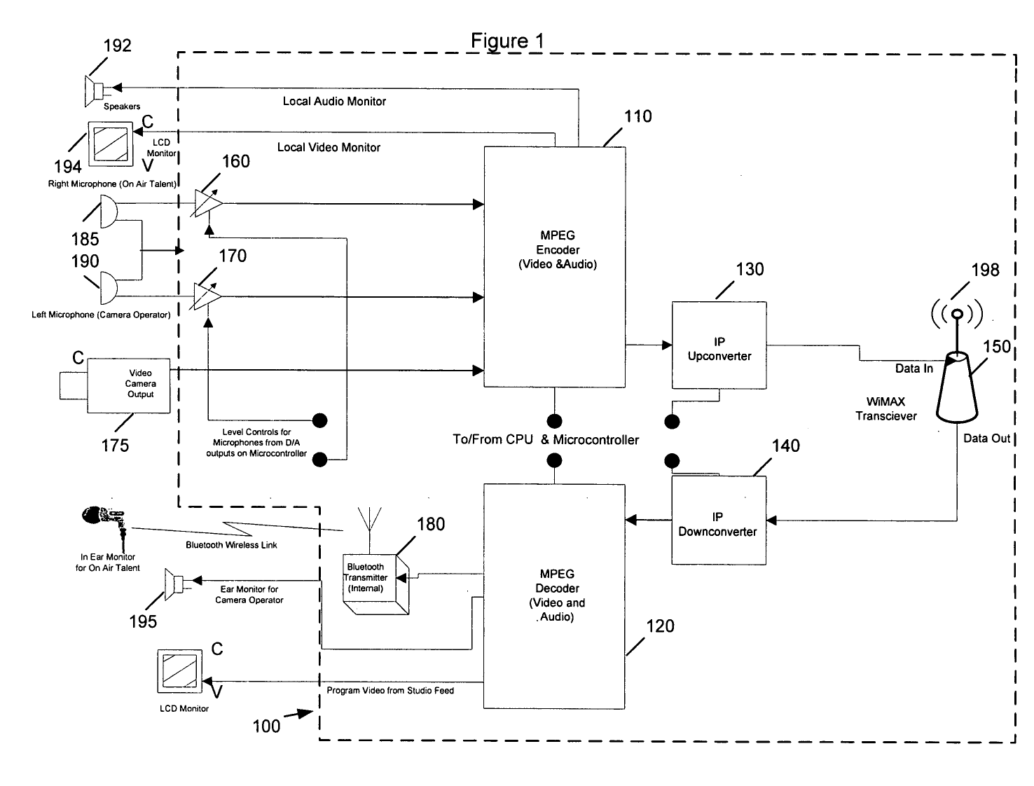

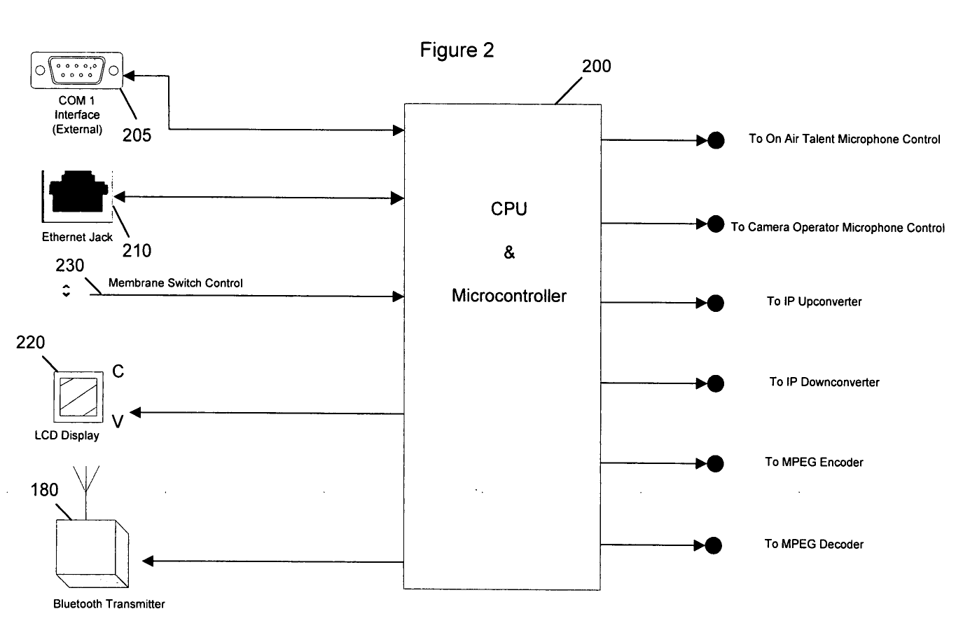

An appliance 100 according to a first embodiment of the invention is shown in FIG. 1. FIG. 2 shows a microcontroller 200 used to control one or more of the components shown in FIG. 1. The appliance 100 is a stand-alone, self-contained full duplex device that accepts input from a digital or analog media source (video, audio, and/or data), and encodes or compresses (e.g., using the MPEG standard) that source to a network transportable network type (e.g., using the IP standard), whereby it may also compensate for network limitations and buffer the data stream if necessary.

The appliance 100 according to the first embodiment includes two modules: an encoder/decoder module and an interfaced wireless transceiver module. In FIG. 1, the encoder/decoder module includes an MPEG Encoder 110, an MPEG Decoder 120, an Upconverter to IP unit 130, and a Downcoverter to IP unit 140. The interface wireless transceiver module includes a WiMAX transceiver 150.

A camera (held by the remotely-located camera operator) provides video data, via a camera video output 175, to a first input port of the MPEG Encoder 110, whereby the MPEG Encoder 110 converts the video data to MPEG-encoded video data. A first microphone 190 provides audio data to a second input port of the MPEG Encoder, whereby the first microphone may be provided on the camera, nearby the camera, or worn or held by the camera operator. The first microphone 190 provides an audio signal corresponding to sounds picked up at an area where a remote broadcast is being made. A second microphone 185 provides audio data to a third input port of the MPEG Encoder, whereby the second microphone 185 may be worn on the ear of the on-air talent to provide his/her oral report to the television studio, for broadcast on a television program (e.g., news program).

The first module accepts an array of analog video or digital video inputs, as well as a main balanced audio input at mic or line level, an alternate audio input comprised of a mic from the camera operator, an audio output for a standard In Ear Monitor (IEM) as well as a Bluetooth IEM, an Ethernet port, and an auxiliary DC power input to power the appliance remotely. The appliance according to the first embodiment can handle standard definition video (analog) and high definition video (component or SDI interface).

A first variable amplifier 160 is provided on a communications line connecting the first microphone 190 to the MPEG Encoder 110. A second variable amplifier 170 is provided on a communications line connecting the second microphone to the MPEG Encoder 110. A Microcontroller 200 (see FIG. 2) controls the audio level of the outputs of the first and second microphones 190, 185, so that they are at an appropriate level. For example, prior to actual broadcast from a remote location, the producer at a television studio may request an “audio check” be made by the on-air talent at the remote location, whereby, based on the sounds being received at the television studio, the producer may instruct the camera operator to adjust the levels of one or both of the first and second microphones 190, 185. These instructions are audio instructions provided from the broadcast studio by way of the IFB, whereby these audio instructions are received by the full-duplex appliance and provided to the appropriate person or persons at the remote location. In one implementation of the first embodiment, a membrane switch control 230 is provided on an exterior housing of the appliance 100 or on the camera, whereby the camera operator adjusts the membrane switch 230 as instructed by the director or producer at the broadcast studio (in an alternative implementation of this embodiment, a thumbwheel switch is provided instead of the membrane switch, whereby thumbwheel control buttons are operated by the camera operator, which provide inputs to the microcontroller 200).

The level-controlled audio inputs and the video input to the MPEG encoder 110 are encoded, whereby MPEG, a well-known industry standard for encoding and compression, is used in the first embodiment to provide such encoding. The video and audio are MPEG encoded in either 2:, 4:2:0, or 4:2:2 format, for example. Those skilled in the art will recognize that other types of encoding may be utilized, while remaining within the spirit and scope of the invention.

The MPEG-encoded audio and video data output by the MPEG encoder is input to an Upconverter to IP unit 130, which upconverts the baseband audio and video data to an appropriate frequency for transmission by way of a network (e.g., an appropriate frequency for communicating over a WiMAX network). For example, the baseband signals may be upconverted to a frequency in the MHz or GHz frequency range via a carrier signal, as is known to those skilled in the communications arts. The Microcontroller 200 also is capable of controlling the Upconverter to IP unit 130, as needed. This control can be performed based on the data rate to be output over the network, and/or when a different upconversion frequency is to be utilized instead of one that has been previously used (e.g., due to Quality of Service information received at the remote location that indicates a poor choice of upconversion frequency, the upconversion frequency is changed to another frequency that may experience less signal degradation).

In the first embodiment, the upcoverted audio and video data is also converted by the Upconverter to IP unit 130 to an Internet Protocol (IP) signal, in a manner known to those skilled in the art. Those skilled in the art will also recognize that other types of signal conversion may be used to suit a particular network for which the data is to be sent from the remote location to the central location, while remaining within the spirit and scope of the invention.

The upconverted audio and video data output by the Upconverter to IP unit 130 is received by Transceiver 150, which may be a WiMAX transceiver in one possible implementation. The Transceiver 150 outputs data according to IEEE 802 standard, whereby the data is output via an Antenna 198 connected to the Transceiver 150, to be sent over-the-air (wirelessly) to the broadcast studio (or other central location).

The WiMAX Transceiver 150 is responsible for establishing network connectivity from the remote location to the broadcast studio. Once connectivity is established, video and/or data is encoded and streamed from the remote location to a network server that is located in the broadcast studio. The network server is responsible for decoding the digital data stream from the remote location into either a broadcast quality video and audio input to a broadcast studio switching matrix, or a digital data stream that will can be matrixed via a central router in the master control or production suite located at the broadcast studio. The network server takes an audio feed (IFB) from the producer and/or director at the broadcast studio and digitizes it for transmission to the remote location via an alternate audio channel, discussed in more detail below.

The alternate audio channel originating from the broadcast studio and received at the remote location is decoded in the first module, after having first been received by the Transceiver 150 (to be specific, signals are received by the Antenna 198 and then provided to the Transceiver 150, i.e., the Antenna 198 is a dual antenna capable of transmitting and receiving signals at the same time, but at different frequency bands). The audio is then split and interfaced within the appliance 100. In one possible implementation, this interface is via a Bluetooth transmitter 180 that provides audio to a Bluetooth ear piece that the on-air talent will be wearing. The other half of the IFB audio is routed internally to a phono type connector 195, such as a ¼″ phono type connector that can be interfaced with an earpiece that the camera operator will be wearing. This enables an IFB conduit between the producer/director at the broadcast studio and the on-air talent and camera operator at the remote location. Program video from the studio feed that is output from the MPEG decoder 120 can be displayed on an LCD monitor, or other type of monitor (e.g., TFT display), for viewing at the remote location.

Thus, unlike the conventional systems that typically rely on a separate cellular phone link to establish the IFB link, the IFB link in the first embodiment is the second of the two duplex links (the first link providing audio and video data from the remote location to the broadcast studio), by which both the camera operator and the on-air talent can be instructed by the producer (located at the broadcast studio) as required (e.g., pan out the camera shot instruction to the camera operator, and instruction to the on-air talent to talk about a particular aspect of the event occurring at the remote location).

The components utilized to receive the IFB link in the appliance 100 are shown in FIG. 1 as the Transceiver 150, a Downconverter to IP unit 140, and a Decoder unit 120. The Microcontroller 200 shown in FIG. 2 is also used to control one or more of those components, as required. The IFB data output from the broadcast studio is received by the Transceiver 150, and this can be done concurrently with the transmission of uplink audio and video data from the Transceiver 150 to the broadcast studio. Further, as shown in FIG. 2, the Microcontroller 200 has a bi-directional communications line to an Ethernet jack 210, whereby communications to/from a network via the Ethernet jack 210 are made. Still further, the Microcontroller 200 has a bi-directional communications line to a COM1 interface 205, which may correspond to an external interface. Operations of thumbwheel control buttons 230, 240, such as described above to change the audio output level, are input to the Microcontroller 200. The Microcontroller 200 is also configured to provide video received from the Downlink (as provided from the broadcast studio) to a Display 220. Also, the Microcontroller 200 is configured to provide audio data over-the-air to a Bluetooth transmitter 180 that may be worn by one or more persons located at the remote location.

The IFB data is data that has been MPEG encoded and converted to an IP signal at the broadcast studio, prior to transmission over the network. The IFB data received by the transceiver is downconverted to a baseband signal by the Downconverter to IP unit 140, and the IP protocol information (e.g., header data, etc.) is stripped off the data stream. The output of the Downconverter is provided to the Decoder unit 129, whereby the MPEG encoding of the data is stripped off the data stream. The resultant IFB audio data is provided to the camera operator's earpiece 195 (via a first output of the Decoder unit) and the on-air talent's earpiece via a Bluetooth transmitter 180 (via a second output of the Decoder unit), whereby the on-air talent may receive that audio over-the-air via a Bluetooth device worn on the ear of the on-air talent.

While just the reception and conversion of audio data on the downlink from the broadcast studio and the remote location is discussed above, the downlink may also include video data provided by the broadcast studio (or other central location) to the remote location. For example, conventional practice is for the on-air talent to view a television monitor that is directly receiving the signal from the public broadcast, provided out of camera range at the remote location, as a way for the on-air talent to “see” what is actually being broadcast. The first embodiment eliminates this unnecessary requirement by providing video data to the remote location via the downlink. The video data is fed to a Liquid Crystal Display (LCD) 220 or a Thin-Film Transistor (TFT) display attached to the appliance's outer housing and/or on a portion of the camera facing the on-air talent, so that persons at the remote location can readily discern in real time what is actually being broadcast by the broadcast studio. Also, local audio and local video can be provided to speakers 192 and a monitor (e.g., LCD monitor) 194 provided at the remote location, via the MPEG Encoder 110, so that the camera operator and the on-air talent can hear and see in real time exactly what they are broadcasting to the broadcast studio.

The network utilized in the first embodiment is a WiMAX network, as described above, which is a shared network that can be used by anyone who has a wireless device. This is different from the conventional approaches of broadcasting from a remote location whereby a dedicated link is used between the broadcast studio and the remotely-located camera operator and on-air talent. Accordingly, in the first embodiment, to deal with situations where the network by which the uplink and downlink of the full duplex operation are contesting with others (e.g., the broadcast is being made at a same location where many other broadcasters are broadcasting to their respective broadcast studios), it may be necessary to limit the bandwidth of audio and video data that is to be output over the network. In those instances, the data rate of the uplink and the downlink can be adjusted so that the signal quality is acceptable, so that the network will not accept any higher data rate due to high demand on the network. Accordingly, the Microcontroller 200 can be used to adjust the Encoder unit 110, the Upconverter to IP unit 130, the Decoder unit 120, and the Downconverter to IP unit 140, based on the current data rate to be utilized for the uplink and the downlink.

The appliance according to the first embodiment may provide an interface for status and telemetry through the TFT display or the LCD display 220. Status can be defined as “clear to send”, “hurry up/battery indicator”, “command and control,” “warning,” “ready,” “link up/down,” etc. Other telemetry information that can be displayed via the TFT/LCD display can be Voltage, Current, Temperature, RF output power, video format, MPEG lock, audio gain, audio VU meters, and system alarms.

The appliance according to the first embodiment also may provide “Quality of Service” (QoS) statistical information. This information may be monitored real time, or stored to be reviewed later. The QoS information can be used for manipulation of the configuration settings to enhance or optimize the quality of the signal being transmitted based on varying performance measurements. For example, based on the QoS of the data being received at the broadcast studio, the director may instruct the camera operator (via the IFB) to change the data rate of the audio and video data being uplinked to the broadcast studio from the remote location, and/or change the encoding/compression parameters and/or amplifier levels of the variable-gain amplifiers 160, 170. In an alternative implementation, based on QoS information monitored by the appliance 100, the microcontroller 200 may automatically adjust one or more of the encoding/compression parameters and data rate to provide an acceptable signal for broadcasting by the broadcast studio to its customers.

As discussed in detail above, the appliance 100 according to the first embodiment is connected to a wireless network to transmit information to a destination (where the broadcast studio is located), but it can alternatively be connected to a wired network to transmit information to the destination. In one possible implementation, the network is a WiMAX network as discussed in detail above, but it may alternatively be the Internet, a Metropolitan Area Network (MAN), or other private network, such as a corporate Local Area Network (LAN) or Wide Area Network (WAN), or a virtual private network (VPN), or a cellular (TDMA, GSM or CDMA) network, or other broadband wireless network (such as Wi-Fi or Wi-Bro.). For these alternative implementations, the WiMAX transceiver is replaced with an appropriate transceiver (e.g., Wi-Fi transceiver for Wi-Fi network, Wi-Bro transceiver for Wi-Bro network) to transmit and receive signals over these networks.

In the first embodiment, the appliance 100 can be “polled” for source input or it can push the source input feed across a network to a destination (e.g., a television studio). As discussed above, the appliance 100 operates in full duplex by way of the 2-way audio link called Interruptible Fold Back (IFB) between the camera operator, on-air talent, and the studio production/control. The IFB essentially corresponds to the audio feed from the program that is currently being broadcast, whereby the broadcast studio has the option to interrupt the program audio in order to communicate directly with the camera operator and/or the on-air talent at the remote location. The camera operator has the ability to communicate back to the studio on a different back-channel audio feed in accordance with the first embodiment, whereby this audio will not be a part of the audio to be broadcast to over a television channel. For example, a right audio channel may be used to provide to-be-broadcast audio to the network server (via the appliance 100), and a left audio channel may be used to provide comments from the camera operator to the director or producer, whereby those comments are not to be broadcast over the television channel. These two different audio channels are both encoded and upconverted by the appropriate components of the appliance 100, whereby they are separated at the network server of the broadcast studio (e.g., right channel audio data received from the appliance 100 over the WiMAX network is provided to an earpiece of the director or producer, and left channel audio data received from the appliance 100 over the WiMAX network is broadcast over a television channel controlled by the broadcast studio), and routed to the appropriate communication paths within the broadcast studio.

Telemetry/operational status as well as user input can be monitored via a high resolution color TFT display or LCD display 220 provided on the appliance 100 (e.g., on the exterior housing of the appliance) and/or on the outer housing of the camera. User defined input can be controlled using menus, using a sensor wheel and/or buttons.

The appliance 100 may be mounted between the camera housing and a battery, or alternatively as a separate unit connected to the camera and/or a separate antenna. The appliance 100 houses several printed circuit cards (for housing the electronic components making up the various elements shown in FIGS. 1 and 2), and may be on the order of the size of a brick (e.g., 1-3 inches high by 3-5 inches wide by 3-5 inches long). The appliance 100 can draw power from the camera battery (or batteries), or from an external battery source. The battery may be a Lithium-Ion battery in one possible implementation.

The appliance 100 can be operated remotely in any location within the market wireless canopy (e.g., WiMAX network coverage in a city), or it can be connected directly to an Ethernet port for wired LAN/WAN operation. For transmissions from locations outside a city, for example, the Internet may be utilized to transport the audio and video data (using IPv6, for example) from the remote location to the broadcast studio located in the city.

Table 1 below provides details on specifications of one possible implementation of an appliance according to the first embodiment.

TABLE 1
Appliance Specifications
Power

| | |
|---|---|
| Input Range: | TBD (sample 10 to 32 Volts DC under voltage |
| | and reverse polarity protection or through |
| | external battery source 11 to 16 VDC/18 W via |
| | 4 pin LEMO socket) |
| Consumption: | 18 to 24 watts average |

MPEG Encoder

| | |
|---|---|
| Video Input: | Composite |
| SDI Input: | SMPTE 292/259M Level C via BNC |
| | (for HD Video) |
| Video Format: | SDI 270 M bit/s or HD 1080i/720P all format |
| | NTSC w/wo PED, PAL Composite or Component |
| | (for HD Video) |
| SD Frame Size: | 720 × 480, 720 × 576 |
| MPEG Profile: | 2: MP@H/ML |
| | 4:2:0 MP@H/ML |
| | 4:2:2 MP@H/ML |
| GOP Size: | Variable, I/P/B |
| Latency: | 1 or 2 frame(s) delay Maximum |

Audio

| | |
|---|---|
| Channels: | Two stereo pairs, selectable from one analog |
| | mic/line, one analog line level, two digital |
| | AES-EBU or embedded SDI |
| Analog Range: | −60 dBm to +14 dBm continually variable in 1 |
| | dB steps |
| Analog Modes: | Selectable Compressor 1:1 to 10:1 |
| | Selectable soft limiter for levels greater than + |
| | 10 dBm |
| | AGC on/off |
| Coding: | MPEG1 layer 2 audio ISO/IEC 13818-3 |
| Sampling Rate: | 96 to 384 K bits/channel 48 KHz |
| Response: | 20 Hz to 18 KHz, +/−0.5 dB |
| Crosstalk: | Better than 60 dB |
| Input Impedence: | 1000 ohms balance |

User Defined Channel:

| | |
|---|---|
| Input: | Transparent data pipe up to 1 Mbps |

Telemetry:

| | |
|---|---|
| Tx Status: | Voltage, Current, Temperature, RF output power, |
| | video format, MPEG lock, audio gain, audio VU |
| | meters, and system alarms |

Control Panel:

| | |
|---|---|
| Display: | Hi Resolution, 1.5″ color LCD |
| Backlight: | Adjustable Timeout |
| Indication: | Input DC voltage and current, digital VU meters, |
| | video lock and PA enable, alarms voltage and |
| | temperature. |
| Input: | Membrane Switch Input |
| Presets: | User defined |
| Menu: | Interactive basic/advanced menu tree allowing |
| | control of presets, video source, audio source, |
| | audio gains, audio modes, video format, and |
| | encryption mode enable |

Physical:

| | |
|---|---|
| Dimension: | 6.0″ H × 5.7″ W × 3.6″ D |
| Weight: | 2 lbs-2.5 lbs |
| Temp Range: | −10 C. to +45 C. |
| Humidity: | 95% +10 C. to +50 C. |
| Mechanical Interface: | Via inter-changeable interface plates. |

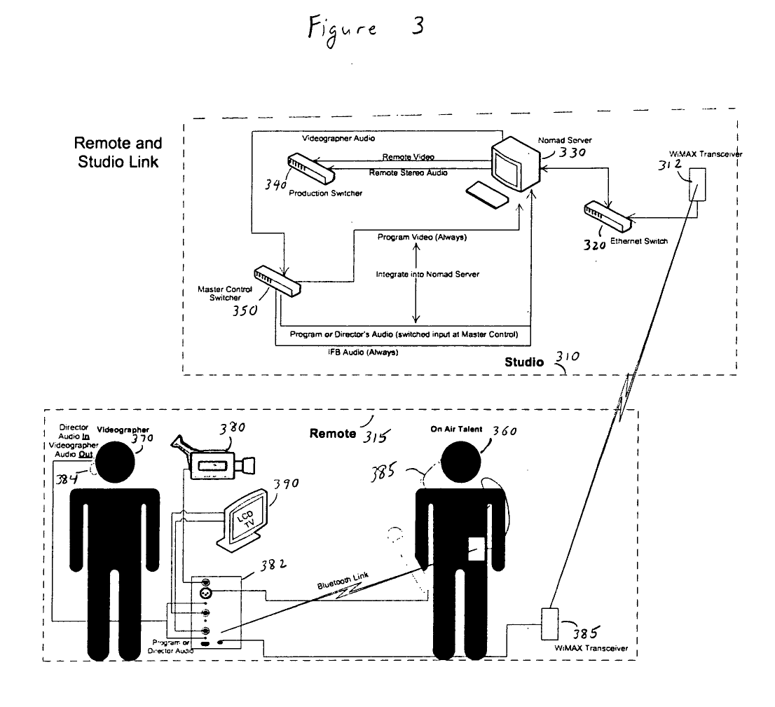

FIG. 3 shows a remote site and a studio site network connectivity, in accordance with an embodiment of the invention. The Studio site 310 includes a WiMax Transceiver 312, an Ethernet Switch 320, a Server 330, a Production Switcher 340, and a Master Control Switcher 350. The Remote site 315 includes On-air Talent (e.g., a reporter for a television station) 360, a Videographer (e.g., cameraperson) 370, a Camera 380, a WiMax transceiver 385, and an LCD TV 390. A control panel 382 (preferably provided on an outer surface of the camera 380) is operable by the videographer 370, whereby audio information provided from a producer or director at the studio site 310 to the videographer 370 causes the videographer 370 to operate one or more of the controls provided on the control panel 382 (e.g., pan camera to a certain location, increase sound of microphone of on-air talent 360). The LCD TV 390 provides a convenient way for the videographer 370 to see exactly what is currently being shown on-the-air, including overlays provided by way of the studio site 310 on video received at the studio site 310 from the remote site 315. The on-air talent 360 has a wireless device 385 attached to his/her head, whereby the wireless device 385 may be a Bluetooth device, and whereby a Wireless link to the camera panel 382 is provided. The videographer 370 wears an earpiece 384 that is connected to receive audio provided by the producer/director, by way of the information received from the WiMax transceiver 385 of the remote site 315 that is forwarded to the control panel 382. The connection of the earpiece 384 to the control panel 382 may be by way of a wired or a wireless connection.

Audio and video recorded by the camera 380 are provided, via the WiMax transceiver 385 at the remote site 315, to the WiMax transceiver 312 to the studio site 310. The received audio and video data is then provided to the Ethernet switch 320, which routes that information to the server 330. The server 330 provides the remote video and remote stereo audio included in the data provided from the remote site 315 to the production switcher 340, whereby the server 330 provides the Videographer audio to the master control switcher 350. The videographer audio is audio that is not meant to be aired on a network broadcast, and is information provided by the Videographer 370 to the producer or director at the studio site 310 to enable the producer/director to make decisions with respect to the remote broadcast currently being aired by the station (e.g., a potential witness to the fire will be available to speak with the on-air talent 360 in about 60 seconds from now). The producer/director at the studio site 310 communicates with the remote site 315 by audio included in a Program or Director's Audio channel, to thereby direct the videographer 370 and the on-air talent 360 during a live, on-air broadcast. The program or director's audio is received by the server 330, and routed to the Ethernet switch 320, for output by the WiMax transceiver 312 of the studio site 310 to the WiMax transceiver 385 of the remote site 315. Program video is also provided from the master control switcher 350 to the server 330, for output to the Ethernet switch 320, to then be sent over-the-air by the WiMax transceiver 312 of the studio site 310 to the WiMax transceiver 385 of the remote site 315. Additionally, an IFB audio channel (described in detail in an earlier portion of this application) is provided between the master control switcher 350 and the server 330, whereby data in the IFB audio channel is provided (via the Ethernet switch 320 and the WiMax transceivers 312, 385) to the on-air talent 360 and the videographer 370.

Many changes or modifications may be made without departing from scope of the invention, which is defined by the appended claims. For example, while a video frame rate of 30 frames per second may be used for transferring data between the remote location and the central location, other frame rates may be used, based on network capabilities and current network demands. The scope of the invention covers current Standard Definition (SD) and High Definition (HD) television signal standards as well as other television signal standards as they are developed. Also, while the central location has been described above as a television broadcast studio, it may alternatively be a local “collection” point for linkage via high bandwidth fiber or satellite link back to a home studio that may be located far away from the local collection point.

What is claimed is:

1. A duplex communications device provided at a first (remote) location for communicating with a second (central) location, comprising:
an encoder unit configured to encode first audio and video data collected at the first location;
an upconverter unit that is configured to convert the encoded first audio and video data to a particular protocol and/or frequency suitable for transmission over a network;
a transceiver unit configured to transmit the upconverted first audio and video data over a network to the second location, wherein the transceiver unit is further configured to receive encoded second audio and/or video data sent over the network from the second location at the particular protocol and/or frequency suitable for transmission over the network;
a downconverter unit that is configured to convert the encoded second audio and/or video data to strip the particular protocol and/or frequency used for transmission over the network from the received second audio and/or video data, to obtain baseband encoded audio and/or video data; and
a decoder unit that is configured to decode the baseband encoded audio and/or video data to obtain decoded second audio and/or video data.

2. The device according to claim 1, wherein the upconverter performs IP conversion of the first audio and video data.

3. The device according to claim 1, wherein the encoder unit performs MPEG encoding, and the decoder unit performs MPEG decoding.

4. The device according to claim 1, wherein the transceiver unit is a WiMAX transceiver.

5. The device according to claim 1, wherein the transceiver unit is an Ethernet transceiver.

6. The device according to claim 1, wherein the transceiver unit is an cellular or Wi-Fi or other wireless broadband transceiver.

7. The device according to claim 1, further comprising a microcontroller configured to control at least one of the encoder unit, the decoder unit, the upconverter unit and the downconverter unit.

8. The device according to claim 1, further comprising:
a first variable-gain amplifier provided along a first communications line that provides a first audio data stream to the encoder unit; and
a second variable-gain amplifier provided along a second communications line that provides a second audio data stream to the encoder unit.

9. The device according to claim 1, further comprising a display configured to display the decoded second video data output by the decoder unit.

10. A device according to claim 9, wherein the display is a TFT display or an LCD display.

11. The device according to claim 1, wherein the first audio and video data provided to the encoder unit is provided by way of a camera at the first location having a microphone attached thereto.

12. A method for providing full duplex communications between a first location and a second location, comprising:
encoding first audio and video data at the first location;
converting, at the first location, the encoded first audio and video data to a particular protocol and/or frequency suitable for transmission over a network;
transmitting, at the first location, the upconverted first audio and video data over a network to the second location;
receiving, at the first location, encoded second audio and/or video data sent over the network from the second location at the particular protocol and/or frequency suitable for transmission over the network;
converting, at the first location, the encoded second audio and/or video data to strip the particular protocol and/or frequency used for transmission over the network from the received second audio and/or video data, to obtain baseband encoded second audio and/or video data; and
decoding, at the first location, the baseband encoded second audio and/or video data to obtain decoded audio and/or video data.

13. The method according to claim 12, wherein the upconverting step performs IP conversion of the first audio and video data.

14. The method according to claim 12, wherein the encoding step performs MPEG encoding, and the decoding step performs MPEG decoding.

15. The method according to claim 14, wherein the network is a WiMAX network or an Ethernet network.

16. The method according to claim 12, further comprising controlling, by way of a controller, at least one of encoding used in the encoding step, decoding used in the decoding step, upconverting used in the upconverting step, and downconverting used in the downconverting step.

17. The method according to claim 12, further comprising displaying, by way of a display, the decoded second video data output by the decoding step.

18. The method according to claim 17, wherein the display is a TFT display or an LCD display.

19. The method according to claim 12, wherein the first audio and video data encoded by the encoding step is provided by way of a camera at the first location having a microphone attached thereto.

20. A duplex communications device for enabling duplex communications between a first location and a second location, comprising a transceiver unit at the first location configured to transmit first audio and video data over a wireless network to the second location, and configured to receive second audio and/or video data sent over the wireless network from the second location.

21. The device according to claim 20, wherein the transceiver unit is a WiMAX transceiver.
